(19) United States
(12) Patent Application Publication
(10) Pub. No.: US 2004/0217682 A1
(43) Pub. Date: Nov. 4, 2004

(54) Mask structure for use in color CRT and Color CRT

(76) Inventors: Hisanobu Tokunaga, Tokyo (JP); Kiyoshi Aoki, Tokyo (JP)

Correspondence Address: BIRCH STEWART KOLASCH & BIRCH, PO BOX 747, FALLS CHURCH, VA, 22040-0747, US

(21) Appl. No.: 10/712,048

(22) Filed: Nov. 14, 2003

(30) Foreign Application Priority Data
Apr. 30, 2003 (JP) 2003-124717

(51) Int. Cl. H01J 29/80

(52) U.S. Cl. 313/402; 313/403; 313/407

(57) ABSTRACT

A mask structure for use in a color CRT includes a color-separating mask made of a thin metal plate having a row of slits formed therein with a predetermined pitch, and a mask frame holding the color-separating mask while applying tension perpendicular to a direction in which the slits are arranged to the color-separating mask. The color-separating mask has a first hole-bearing area including all of the slits of the row except two outermost slits of the row, and two second hole-bearing areas each of which includes one of the outermost slits. The thin metal plate has projections formed therein for each of the outermost slits, the projections protruding to an opening of corresponding one of the outermost slits. The opening area of the outermost slits of the second hole bearing areas is smaller than the opening area of the slits of the first hole bearing area.

### BACKGROUND OF THE INVENTION

1. Field of the Invention

The present invention relates to a mask structure for use in a color CRT, specifically relates to the shape of slits formed in rows in a color-separating mask thereof.

2. Description of Related Art

It is known to provide an aperture grille, which is a kind of the color-separating mask, with an extra slit next to outermost one of their slits formed in rows (referred to as “stripe slits” hereinafter) on either side thereof, the extra slit being at a distance of a slit pitch or twice the slit pitch from the outermost stripe slit and having a width smaller than that of the stripe slits. The extra slit is tapered towards its ends that are in alignment with the ends of the stripe slits. Alternatively, the extra slit is made shorter than the stripe slits, so that each end of the extra slit is at a distance of twice the slit pitch from the ends of the stripe slits. For example, refer to Japanese Patent No. 3158297.

It is also known to provide the aperture grille made of a thin metal plate with plural extra slits outside its outermost stripe slit on either side thereof. These plural extra slits have the same pitch as that of the stripe slits and the width smaller than that of the stripe slits. These plural extra slits have also light blocking capability. For example, refer to Japanese Patent No. 3194290.

Generally, the mask structure installed within a color CRT comprises a color-separating mask having a number of electron beam passing holes formed therein by a selective etching process, and a mask frame for supporting the color-separating mask. The color-separating mask is referred to as “aperture grille” if it is of the type having a number of equally spaced sliver elements (or grille elements). A slit between adjacent sliver elements serves as an electron beam passing hole.

Incidentally, in the process of assembling the mask structure including the color-separating mask of tension type, which is typified by the aperture grille, the color-separating mask is joined or welded to the mask frame being applied with a certain pressure at several portions thereof and thereby deformed. When the pressure is released after this process, the resilience of the mask frame gives a certain tension to the color-separating mask. A distribution curve of the tension applied to the color-separating mask may vary due to variation in the pressure applied to the mask frame during the assembling process or variation in the resilience of the mask frame itself. This variation in the distribution curve of the tension affects the width of the outermost slit of the color-separating mask in particular. If a resultant variation in the width of the outermost slit is large, an effective screen formed in a subsequent fluorescent surface forming process can be defective as explained in detail later.

To remove such a problem, the Japanese Patent No. 3158297 and the Japanese Patent No. 3194290 suggest forming the above-described extra slit or slits next to the outermost stripe slit. These extra slits disclosed in these patents do not directly contribute to the formation of the effective screen since they block an exposure light in the fluorescent surface forming process.

However, two sliver elements on both sides of the extra slit may contact with each other if the width of the extra slit is narrowed excessively as a consequence of the variation in the distribution curve of the tension during the process of assembling the color-separating mask of the tension type (aperture grille) and the mask frame. Once the adjacent sliver elements contact and become entangled with each other, the productivity is lowered since it is hard to untangle them. This hardness stems from the fact that the entangled sliver elements are in line contact with each other, and a large friction is therefore produced when untangling them.

When such an entanglement occurs, the width of the stripe slit next to the extra slit may be narrowed since the sliver elements on both sides of the extra slit are curved. If the fluorescent surface forming process is carried out in such a state, no fluorescent substance surface is formed in a part corresponding to the stripe slit next to the extra slit, since this part is not exposed to the exposure light sufficiently.

### SUMMARY OF THE INVENTION

An object of the present invention is to remove such a problem, thereby providing a mask structure for use in a color CRT which is easy to assemble and allows the color CRT to display high quality images.

The object is achieved by a mask structure for use in a color CRT comprising:

a color-separating mask made of a thin metal plate having a row of slits formed therein with a predetermined pitch, the color-separating mask having a first hole-bearing area including all of the slits of the row except two outermost slits of the row and two second hole-bearing areas each of which includes one of the outermost slits; and

a mask frame holding the color-separating mask while applying tension perpendicular to a direction in which the slits are arranged to the color-separating mask;

wherein the thin metal plate has first projections formed therein for each of the outermost slits, the first projections protruding to an opening of corresponding one of the outermost slits, and

wherein an opening area of the outermost slits of the second hole bearing areas is smaller than an opening area of the slits of the first hole bearing area.

### BRIEF DESCRIPTION OF THE DRAWINGS

Embodiments of the invention will now be described by way of example and with reference to the accompanying drawings in which:

FIG. 1 is a schematic perspective view of a mask structure of the tension type for use in a color CRT of a first embodiment according to the invention;

FIG. 2 is a plan view of a color-separating mask of the mask structure of the tension type of the first embodiment;

FIG. 3 is a fragmentary enlarged view of the color-separating mask shown in FIG. 2;

FIG. 4(a) shows a part of the color-separating mask of the mask structure of the tension type assembled without a hitch;

FIG. 4(b) shows the part of the color-separating mask of the mask structure of the tension type when abnormality occurs to the color-separating mask due to variation in distribution curve of the tension applied to the color-separating mask during the assembling process;

FIG. 5 is a plan view of a color-separating mask of a mask structure of the tension type for use in a color CRT of a second embodiment according to the invention;

FIG. 6 is a fragmentary enlarged view of the color-separating mask shown in FIG. 5;

FIG. 7 shows a second hole-bearing area and its vicinity on large scale of the color-separating mask shown in FIG. 6;

FIG. 8 shows a color-separating mask of a variant of the mask structure of the second embodiment;

FIG. 9 shows a color-separating mask of a variant of the mask structure of the second embodiment;

FIG. 10 shows a color-separating mask of a variant of the mask structure of the second embodiment;

FIG. 11 shows principal parts of a color CRT including a mask structure of the tension type; and

FIG. 12 shows light-intensity profiles of the exposure light undergoing Fresnel diffraction by the slits of a color-separating mask in a fluorescent surface forming process.

### DESCRIPTION OF THE PREFERRED EMBODIMENTS

A First Embodiment

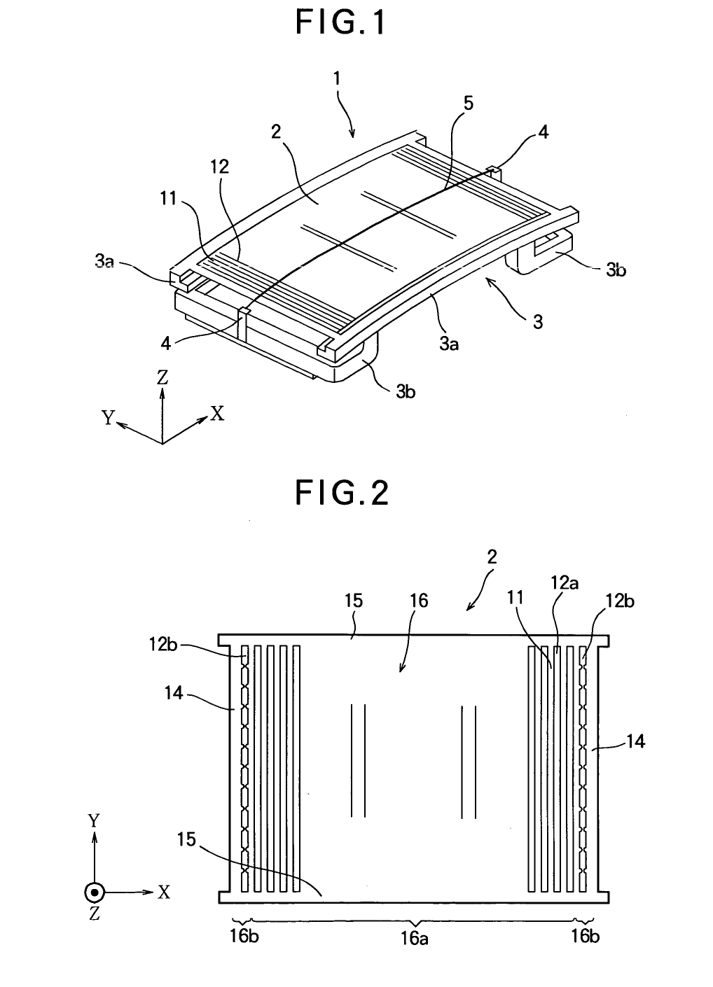

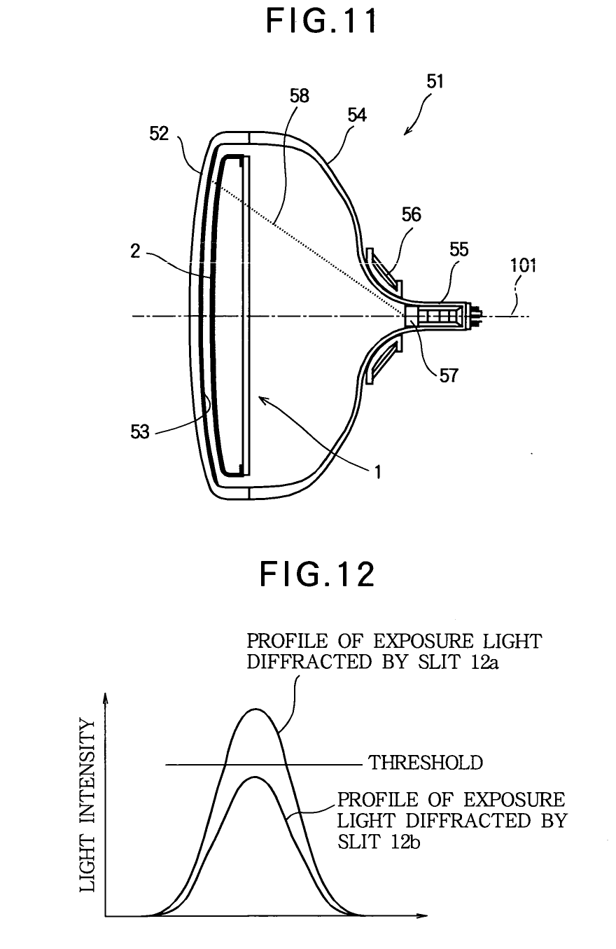

FIG. 1 is a schematic perspective view of a mask structure of the tension type for use in a color CRT of a first embodiment according to the invention. FIG. 11 shows principal parts of a color CRT 51 including this mask structure of the tension type.

As shown in FIG. 11, a glass bulb as a casing of the color CRT 51 includes a face panel 52 having a fluorescent screen 53 formed therein, a funnel 54 fixed to the back of the face panel 52, and a neck 55 integral with the funnel 54.

An electron gun 57 with its axis coinciding a tube axis 101 is disposed within the neck 55. A mask structure 1 of the tension type is disposed within the face panel 52 by not illustrated mounting brackets such that a color-separating electrode (referred to as a color-separating mask hereinafter) 2 thereof faces the fluorescent screen 53.

A deflection yoke 56 for deflecting three electron beams 58 emitted from the electron gun 57 is disposed so as to cover the periphery of the glass bulb between the funnel 54 and the neck 55. The color-separating mask 2 is for landing the three electron beams 58 at red, green, and blue sections of the fluorescent screen 53 respectively.

The mask structure 1 of the tension type including the color-separating mask 2 is explained below with reference to FIG. 1. The X-axis and Y-axis represent a horizontal direction and a vertical direction respectively on the screen when the mask structure 1 of the tension type is installed in place within the face panel 52. The Z-axis represents the tube axis.

As shown in FIG. 1, the mask structure 1 of the tension type is comprised of the color-separating mask 2 and a mask frame 3. The mask frame 3 made of steel lumbers includes a pair of H-members 3a to be welded to a pair of long sides of the color-separating mask 2 for supporting the color-separating mask 2, and a pair of V-members 3b for interconnecting the H-members 3a in such a state that the color-separating mask 2 is held under tension along the Y-axis.

The color-separating mask 2 has a hole-bearing area 16 (see FIG. 2) in which sliver elements 11 extending along the Y-axis parallel to the short sides (or in the vertical direction on the screen) and slits 12a, 12b are interleaved along the X-axis parallel to the long sides (or in the horizontal direction on the screen).

As shown in FIG. 1, the mask structure 1 of the tension type includes a pair of opposite damper springs 4 welded to predetermined positions of the V-members 3b. A damper wire 5 is stretched across the damper springs 4. The hole-bearing area 16 of the aperture grille type tends to develop horizontal vibration, that is, tends to cause sliver elements 11 to vibrate in the side-to-side direction of the screen. The damper wire 5 contacting the sliver elements 11 suppresses and attenuates such vibration by contact friction.

FIG. 2 is a plan view of the color-separating mask 2 of the mask structure 1 of the tension type, and FIG. 3 is a fragmentary enlarged view of the color-separating mask 2. The color-separating mask 2 is explained below with reference to FIGS. 1 to 3.

As shown in FIGS. 1 and 2, the color-separating mask 2 includes connection areas 15 for connection with the mask frame 3 and the hole-bearing area 16 having a number of slits through which the electron beams 58 emitted from the electron gun 57 pass. The slits includes inner slits 12a and outermost slits 12b having a shape different from that of the inner slits 12b. The connection areas 15 are at the both ends of the color-separating mask 2 in the Y-axis direction. The hole-bearing area 16 extends from one end to the other end of the color-separating mask 2 in the X-axis direction, and is put between the connection areas 15 in the Y-axis direction.

As shown in FIGS. 2 and 3, the hole-bearing area 16 comprises a first hole-bearing area 16a and two second hole-bearing areas 16b. The first hole-bearing area 16a has the inner slits 12a, and each of the second hole-bearing areas 16b has the outermost slit 12b which is different from that of the slit 12a in shape. These slits 12a and 12b are formed with a constant pitch in the X-axis direction. These slits 12a and 12b have the same length, and their respective ends are in alignment with one another. In addition, the width w1 of the slits 12a is approximately equal to the width w2 of the slit 12b.

As shown in FIG. 3, the sliver element 11 and an outermost sliver element 14 forming the slit 12b of the second hole-bearing area 16b has semicircular projections 11a and semicircular projections 14a respectively. These projections 11a and 14a are paired such that they are placed on opposite sides of the slit 12b. There is a clearance of wt between the tips of the paired projections 11a and 14a. These pairs are formed in great numbers with a certain pitch in the Y-axis direction.

The first hole-bearing area 16a corresponds to an effective display area of the screen of the color CRT 51 shown in FIG. 11. On the other hand, the second hole-bearing area 16b corresponds to an area outside the effective display area, since the exposure light is blocked by the projections 11a and 14a in the fluorescent surface forming process so that no fluorescent substance surface is formed in a part of the screen corresponding to the second hole-bearing area 16b.

Although the sizes and numbers of the projections 11a, 14a depend on the size of the color CRT, the deflection angle, etc., the opening area of the slit 12b of the second hole-bearing area 16b should be at most 70% of that of the slit 12a of the first hole-bearing area 16a. The height of the projections 11a, 14a in the X-axis direction is between ⅛ and 6/8 of the width w2 of the slit 12b in this embodiment, though the present invention is not limited thereto.

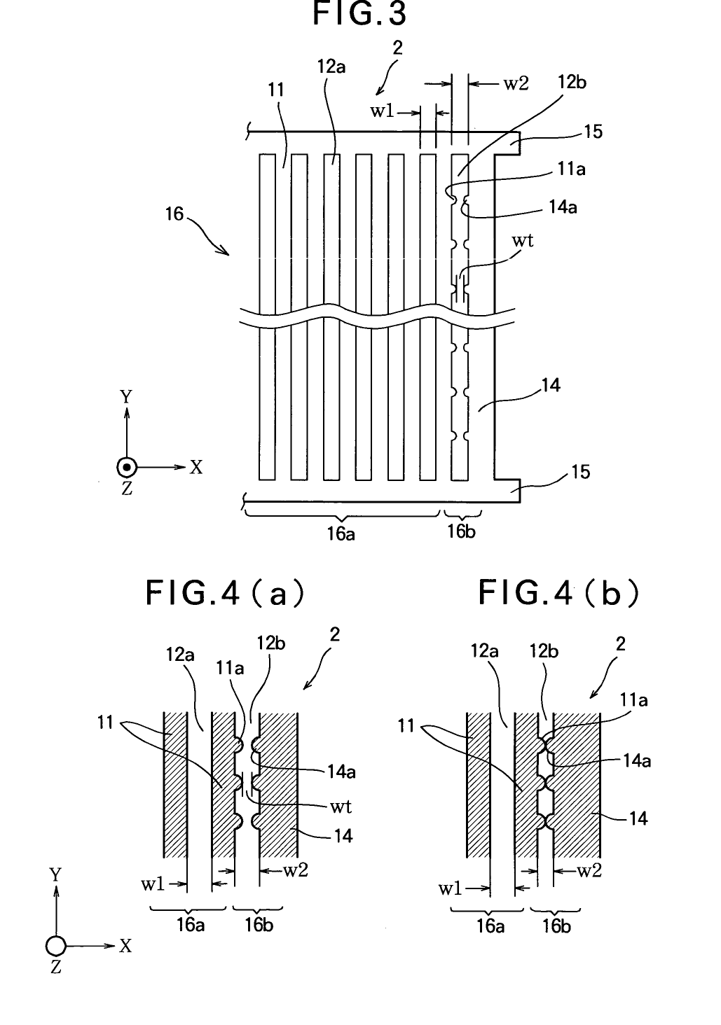

FIGS. 4(a) and 4(b) show the second hole-bearing area 16b and its vicinity of the color-separating mask 2 on large scale. When the mask structure 1 of the tension type is assembled without a hitch, the width w2 of the slit 12b of the second hole-bearing area 16b is approximately equal to the width w1 of the slit 12a of the first hole-bearing area 16a as shown in FIG. 4(a). The sizes and the numbers of the projections 11a and 14a are such as to satisfy the above-explained condition that the opening area of the slit 12b is at most 70% of that of the slit 12a.

In the fluorescent surface forming process, the exposure light undergoes Fresnel diffraction when passing through the color-separating mask 2. As the opening area of the slit becomes smaller, the effect of Fresnel diffraction grows stronger and the intensity of the light that has passed through the slit becomes smaller. FIG. 12 shows light-intensity profiles of the exposure light undergoing Fresnel diffraction by the slit 12a or the slit 12b. As shown in FIG. 12, reducing the opening area of the slit 12b to such an extent that the top of its light-intensity profile is below a certain threshold makes it possible not to form a fluorescent substance surface in a part of the screen corresponding to the slit 12b. Experience shows that the top of the light-intensity profile is below the threshold if the opening area of the slit 12b of the second hole-bearing area 16b is smaller than 70% of that of the slits 12a of the first hole-bearing area 16a.

Accordingly, it is possible to form a fluorescent substance surface on the screen only in a part facing the first hole-bearing area 16a by carrying out the fluorescent surface forming process with the color-separating mask 2 satisfying the above described condition, while causing other parts facing the second hole-bearing areas 16b to be outside the effective display area.

FIG. 4(b) shows a case where abnormality due to variation in the distribution curve of the tension applied to the color-separating mask 2 has occurred to the second hole-bearing area 16b during the assembling process of the mask structure 1 of the tension type.

Even if the sliver element 11 and the outermost sliver element 14 opposed to each other come into contact with each other when the width w2 of the slit 12b of the second hole-bearing area 16b becomes narrower than the width w1 of the slit 12a of the first hole-bearing area 16a as shown in FIG. 4(b), their contact friction is small since they are in a point contact. Accordingly they can be untangled easily.

As explained above with reference to FIGS. 2 and 3, since the sliver elements forming the slit 12b of second hole-bearing area 16b of the color-separating mask 2 have the projections 11a and 14a, even if the physical relationship between the color-separating mask 2 and the mask frame 3 is wrong or the tension applied to the color-separating mask 2 by the mask frame 3 is not uniform during the assembling process of the mask structure 1 of the tension type, and accordingly the variation of the width of the slit 12b of second hole-bearing area 16b is large, it does not affect the subsequent process for forming the fluorescent screen 53 (FIG. 11), because the sliver element 11 resists being entangled with the outermost element 14, and even if the sliver element 11 is entangled with the outermost element 14, they can be untangled easily.

A Second Embodiment

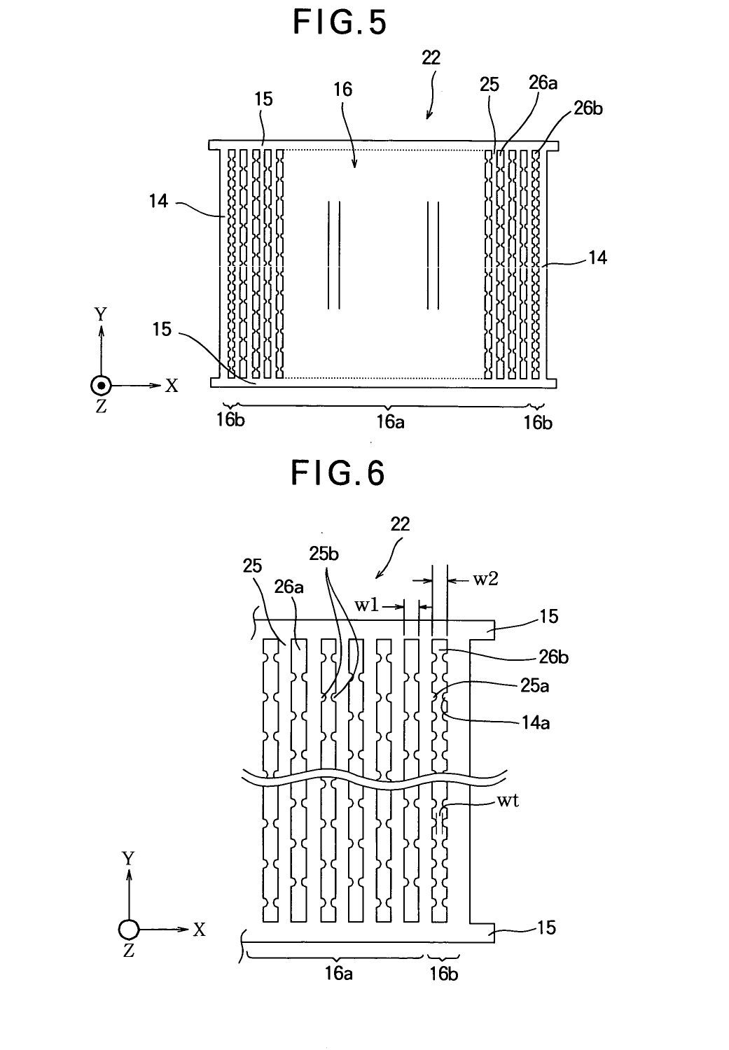

FIG. 5 is a plan view of a color-separating mask 22 of a mask structure of the tension type of a second embodiment according to the invention, and FIG. 6 is a fragmentary enlarged view of the color-separating mask 22.

This color-separating mask 22 can be used for the mask structure 1 of the tension type of the first embodiment instead of the color-separating mask 2. Accordingly, the color-separating mask 22 will be explained below with reference to FIG. 1 supposing that the color-separating mask 22 is fixed to the mask frame 3 by the same assembling process as the first embodiment. The same or corresponding parts of the color-separating mask 22 as those of the color-separating mask 2 are given the identical reference numerals and letters and explanation thereof will be omitted.

As shown in FIGS. 5 and 6, the hole-bearing area 16 comprises the first hole-bearing area 16a and the two second hole-bearing areas 16b. The first hole-bearing area 16a has inner slits 26a, and each of the second hole-bearing areas 16b has an outermost slit 26b. These slits 26a and 26b are formed with a constant pitch in the X-axis direction. These slits 26a and 26b have the same length, and their respective ends are in alignment with one another. In addition, the width w1 of the slits 26a is approximately equal to the width w2 of the slit 26b.

As shown in FIG. 6, a sliver element 25 and the outermost sliver element 14 forming the slit 26b of the second hole-bearing area 16b have semicircular projections 25a and semicircular projections 14a. These projections 11a and 14a are paired such that they are placed on opposite sides of the slit 12b. There is a clearance of wt between the tips of the paired projections 25aand 14a. These pairs are formed in great numbers with a certain pitch in the Y-axis direction.

In this embodiment, the sliver elements 25 forming the slits 26a in the first hole-bearing area 16a also have paired projections 25b placed on opposite sides of the slit 26a. There is a certain clearance between the tips of the paired projections 25b. These pairs are formed in great numbers with a constant pitch in the Y-axis direction. These projections 25b formed in the color-separating mask 22 with the constant pitch in the Y-axis direction may cause moire phenomena depending on the pitch of scanning lines of the CRT. Accordingly, the pitch in the Y-axis direction of the paired projections 25b is determined depending on the spec of the CRT that uses this color-separating mask 22.

The first hole-bearing area 16a corresponds to the effective display area of the screen 53 of the color CRT 51 shown in FIG. 11. On the other hand, the second hole-bearing area 16b corresponds to an area outside the effective display area, since the exposure light is blocked by the projections 25a and 14a in the fluorescent surface forming process so that no fluorescent substance surface is formed in a part of the screen corresponding to the second hole-bearing area 16b.

Although the sizes and the numbers of the projections 25a, 14a depend on the size of the color CRT, the deflection angle, etc., the opening area of the slit 26b of the second hole-bearing area 16b should be at most 70% of that of the slit 26a of the first hole-bearing area 16a.

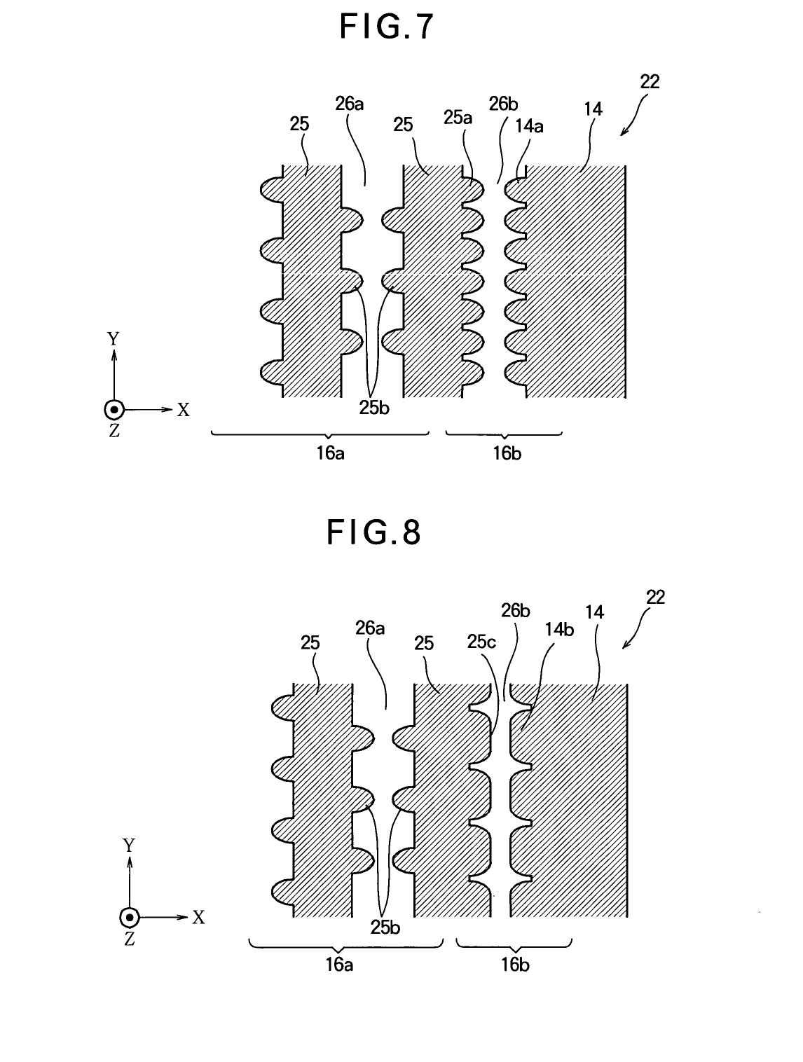

FIG. 7 shows the second hole-bearing area 16 and its vicinity on large scale of the color-separating mask 2 shown in FIG. 6. The paired projections 25a and 14a in the slit 26b of the second hole-bearing area 16b are formed with a pitch shorter than that of the paired projections 25b in the slit 26a of the first hole-bearing area 16a so that the opening area of the slit 26b is smaller than 70% of that of the slit 26a. With the color-separating mask 22 explained above, it is possible to form a fluorescent substance surface only in a part facing the first hole-bearing area 16a, while causing other parts facing the second hole-bearing areas 16b to be outside the effective display area of the screen in the fluorescent surface forming process.

If the pitch of the paired projections 25a and 14ain the slit 26b is too small, and it is therefore difficult to etch the thin metal plate with the slit 26b in forming the color-separating mask 22, the projections 25a, 14a may be replaced by projections 25c and 14b having a wider width and a longer pitch as shown in FIG. 8. In this case, however, the effect of reducing the friction resistance between entangled projections is lowered in some degree since the contact area between them is large.

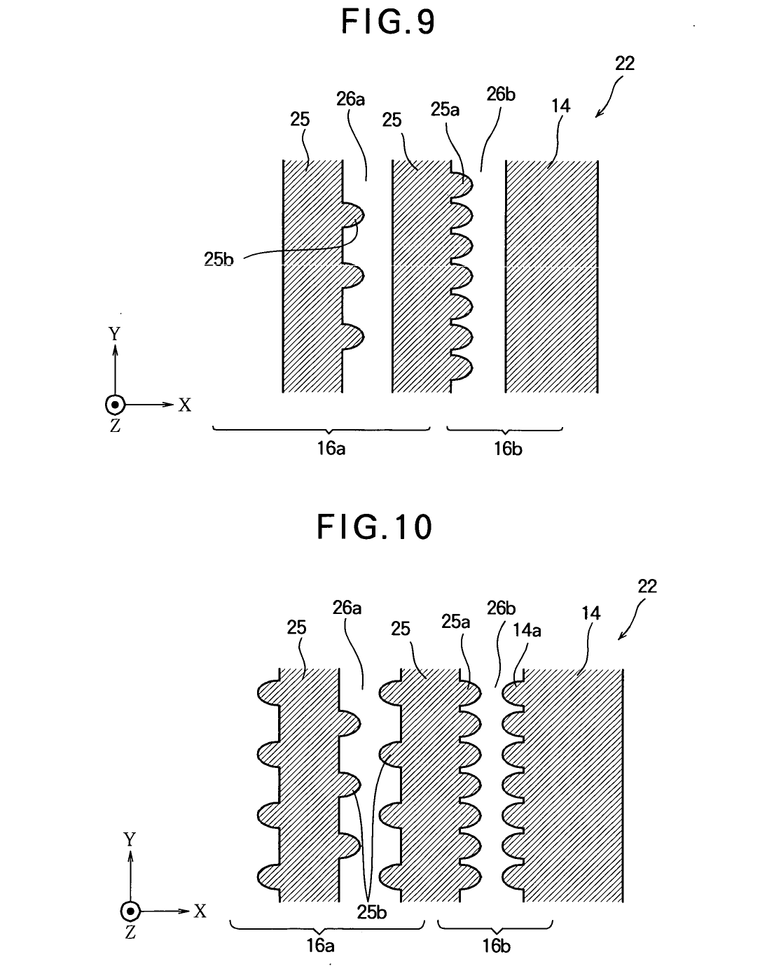

Although the paired projections 25b and the paired projections 25a, 14a are formed such that they protrude inward from the edges on opposite sides of the opening of the slit 26a or 26b as shown in FIG. 5 and FIG. 6, it is permissible to form the projections 25b, 25a only in one side of the opening of the slit 26a, 26b as shown in FIG. 9. It is also permissible to form the projections 25b on opposite sides of the opening of the slit 26a in a staggered format as shown in FIG. 10.

With the mask structure of the tension type of the second embodiment having the above-described color-separating mask 22, it is possible to prevent entanglement between neighboring sliver elements previously caused by vibration during the processes for manufacturing the CRT or a cross hatch signal supplied to the CRT as a test signal from occurring not only in the second hole-bearing area 16b but in the first hole-bearing area 16a as well. Although the projections are formed to take the shape of a semicircle in the foregoing embodiments, they may have various shapes without losing their effects. For example, they may be square or triangular.

The above explained preferred embodiments are exemplary of the invention of the present application which is described solely by the claims appended below. It should be understood that modifications of the preferred embodiments may be made as would occur to one of skill in the art.

What is claimed is:

1. A mask structure for use in a color CRT comprising:
a color-separating mask made of a thin metal plate having a row of slits formed therein with a predetermined pitch, the color-separating mask having a first hole-bearing area including all of the slits of the row except two outermost slits of the row and two second hole-bearing areas each of which includes one of the outermost slits; and
a mask frame holding the color-separating mask while applying tension perpendicular to a direction in which the slits are arranged to the color-separating mask;
wherein the thin metal plate has first projections formed therein for each of the outermost slits, the first projections protruding to an opening of corresponding one of the outermost slits, and
wherein an opening area of the outermost slits of the second hole bearing areas is smaller than an opening area of the slits of the first hole bearing area.

2. A mask structure for use in a color CRT according to claim 1, in which the opening area of the outermost slits of the second hole-bearing areas is smaller than 70% of the opening area of the slits of the first hole-bearing area.

3. A mask structure for use in a color CRT according to claim 1, in which the thin metal plate has second projections formed therein for each of the slits of the first hole-bearing area, the second projections protruding to an opening of corresponding one of the slits of the first hole-bearing area.

4. A mask structure for use in a color CRT according to claim 1, in which the first projections are formed in pairs of projections on opposite sides of the opening of the outermost slit of the second hole-bearing area with a predetermined pitch in a direction of length of the outermost slit.

5. A mask structure for use in a color CRT according to claim 3, in which the first projections are formed in pairs of projections on opposite sides of the opening of the outermost slit of the second hole-bearing area with a predetermined pitch in a direction of length of the outermost slit, and the second projections are formed in pairs of projections on opposite sides of the opening of the slit of the first hole-bearing area with a predetermined pitch in a direction of length of the slit of the first hole-bearing area.

6. A mask structure for use in a color CRT according to claim 1, in which the first projections are formed on only one of opposite sides of the opening of the outermost slit of the second hole-bearing area with a predetermined pitch in a direction of length of the outermost slit of the second hole-bearing area.

7. A mask structure for use in a color CRT according to claim 3, in which the first projections are formed on only one of opposite sides of the opening of the outermost slit of the second hole-bearing area with a predetermined pitch in a direction of length of the outermost slit, and the second projections are formed on only one of opposite sides of the opening of the slit of the first hole-bearing area with a predetermined pitch in a direction of length of the slit of the first hole-bearing area.

8. A mask structure for use in a color CRT according to claim 3, in which the second projections are formed on opposite sides of the opening of the slit of the first hole-bearing area in a staggered format with a predetermined pitch in a direction of length of the slit of the first hole-bearing area.

9. A color CRT including the mask structure as described in any one of claims 1 to 8.
